(19) United States
(12) Patent Application Publication
(10) Pub. No.: US 2024/0312733 A1
(43) Pub. Date: Sep. 19, 2024

(54) INTERLOCK DEVICE

(71) Applicant: ABB SCHWEIZ AG, Baden (CH)

(72) Inventors: Tianyi Huang, Xiamen (CN); Jinyu Zhou, Lishui (CN); Deyun Zhang, Xiamen (CN); Jifeng Feng, Shanghai (CN)

(21) Appl. No.: 18/676,129

(22) Filed: May 28, 2024

Related U.S. Application Data
(63) Continuation of application No. PCT/CN2021/143363, filed on Dec. 30, 2021.

(51) Int. Cl. H01H 9/26

(52) U.S. Cl. CPC H01H 9/26; H01H 2300/018

(57) ABSTRACT

An interlock device for a bypass device. The bypass device is configured to switch a load between a main power supply and an auxiliary power supply and includes an Automatic Transfer Switching Equipment having a first switch coupled to the main power supply and a second switch coupled to the auxiliary power supply. The bypass device also includes a Manual Transfer Switching Equipment having a third switch coupled to the main power supply and a fourth switch coupled to the auxiliary power supply. The interlock device includes a mounting plate having a first side and a second side opposite to the first side; a first support member arranged at the first side of the mounting plate; and a first interlock assembly configured to prevent the first switch from being closed when the fourth switch is closed.

### FIELD

Embodiments of the present disclosure generally relate to the field of interlock device, and more particularly, to an interlock device and a bypass device.

### BACKGROUND

Transfer Switching Equipment (TSE) is used for changeover of two power supplies to ensure continuously providing power to important loads. A bypass type TSE (also referred to as a bypass device) typically contains two main parts, Automatic Transfer Switching Equipment (ATSE) and Manual Transfer Switching Equipment (MTSE), each of which comprises two switches to switch the loads between the two power supplies. The ATSE is used to operate in a normal condition and the MTSE is used to operate when the ATSE needs maintenance.

Interlocking is an important functional mechanism of the bypass device, which aims to prevent a short circuit between the two power supplies. To this end, an interlock structure is provided between the ATSE and the MTSE. When the ATSE turns on one of the two power supplies, such as a main power supply, the interlock structure only allows the MTSE to turn on the main power supply, but cannot turn on the other power supply, such as an auxiliary power supply. Similarly, when the MTSE turns on the main power supply, the ATSE cannot turn on the auxiliary power supply. In this way, the interlock structure can avoid the short circuit between the two power supplies due to a wrong operation in the use course of the bypass device.

As the ATSE needs to be swung out of a drawer due to maintenance and other reasons, the connection between the interlock structure and the ATSE must be pluggable. Conventionally, an operation line is utilized to realize the interlocking, but the reliability of the operation line is relatively poor and easy to lead to a failure of the interlocking function. Moreover, a solenoid may be introduced into the mechanism to realize logical interlock in cooperation with a microswitch. Its disadvantage is that the interlock mechanism can only work normally when being powered, and the reliability of the microswitch will have a large impact on the whole system.

### SUMMARY

Example embodiments of the present disclosure provide improved solutions for achieving interlocking function between the ATSE and the MTSE.

In a first aspect of the present disclosure, it is provided an interlock device for a bypass device. The bypass device is configured to switch a load between a main power supply and an auxiliary power supply and comprises an ATSE having a first switch coupled to the main power supply and a second switch coupled to the auxiliary power supply and a MTSE having a third switch coupled to the main power supply and a fourth switch coupled to the auxiliary power supply. The interlock device comprises: a mounting plate having a first side and a second side opposite to the first side; a first support member arranged at the first side of the mounting plate and comprising a first guiding hole extending in a first direction; and a first interlock assembly configured to prevent the first switch from being closed when the fourth switch is closed. The first interlock assembly comprises: a first driving assembly coupled to a fourth main shaft of the fourth switch; and a first blocker coupled to the first driving assembly and being movable along the first guiding hole in the first direction under driving of the first driving assembly when the fourth switch is switched between a close state and an open state, wherein the first blocker is configured to block a first indicator coupled to a first main shaft of the first switch when the fourth switch is in the close state and not block the first indicator when the fourth switch is in the open state. With these embodiments, through using the first blocker to block the first indicator, the interlock device can reliably prevent the first switch from being closed when the fourth switch is closed.

In some embodiments, the first driving assembly comprises: a first cam coupled to the fourth main shaft; a first moving sheet supported by a second support member arranged at the first side of the mounting plate and being movable towards or away from the fourth main shaft with respect to the second support member; a first connecting member coupled between the first cam and the first moving sheet and configured to push the first moving sheet away from the fourth main shaft when the fourth switch is switched from the close state to the open state and pull the first moving sheet towards the fourth main shaft when the fourth switch is switched from the open state to the close state; and a first push bar coupled between the first moving sheet and the first blocker and configured to push the first blocker to a position at which the first indicator is not blocked by the first blocker when the fourth switch is switched from the close state to the open state and allow the first blocker to move to a position at which the first indicator is blocked by the first blocker when the fourth switch is switched from the open state to the close state. With these embodiments, the first driving assembly can transfer the movement of the fourth main shaft to the first blocker reliably and precisely.

In some embodiments, the first connecting member comprises a first link and a second link coupled to each other through fastening elements. With these embodiments, the mounting of the first connecting member is easy to be implemented.

In some embodiments, the first push bar comprises a first strip-shaped hole coupled to the first blocker. With these embodiments, a part of the first blocker can be mounted in the first strip-shaped hole such that the change of the position of the first blocker can be implemented reliably.

In some embodiments, the first driving assembly further comprises a first reset spring coupled between the second support member and the first blocker and configured to reset the first blocker when the fourth switch is in the close state such that the first indicator is blocked by the first blocker. With these embodiments, the first blocker can be reset reliably when the fourth switch is switched from the open state to the close state.

In some embodiments, the first blocker comprises: a first main part extending through a first through hole of the mounting plate; a first driving part arranged at an end of the first main part and coupled to the first driving assembly; and a first block part arranged at the other end of the first main part and configured to block the first indicator when the fourth switch is in the close state and not block the first indicator when the fourth switch is in the open state. With these embodiments, the first blocker is simple in structure and easy to be mounted.

In some embodiments, the first block part comprises a first surface inclined with respect to the first guiding hole in the first direction and configured to block the first indicator when the fourth switch is in the close state. With these embodiments, no matter whether the ATSE is swung to a precise position after the maintenance, the first surface inclined with respect to the first guiding hole can block the first indicator reliably when the fourth switch is in the close state.

In some embodiments, the interlock device further comprises a first brake member arranged near the first guiding hole at the first side of the mounting plate and configured to apply a friction force onto the first blocker when the fourth switch is in the close state. With these embodiments, when the first indicator is blocked by the first blocker, if the first indicator tends to rotate due to an incorrect manipulation, the first indicator will apply a pressing force onto the first blocker. In this case, the first brake member may apply a friction force onto the first blocker, such that the first blocker will not slide with respect to the first indicator.

In some embodiments, the first support member further comprises a second guiding hole extending in a second direction, and the interlock device further comprises a second interlock assembly configured to prevent the second switch from being closed when the third switch is closed and comprising: a second driving assembly coupled to a third main shaft of the third switch; and a second blocker coupled to the second driving assembly and being movable along the second guiding hole in the second direction under driving of the second driving assembly when the third switch is switched between a close state and an open state, wherein the second blocker is configured to block a second indicator coupled to a second main shaft of the second switch when the third switch is in the close state and not block the second indicator when the third switch is in the open state. With these embodiments, through using the second blocker to block the second indicator, the interlock device can reliably prevent the second switch from being closed when the third switch is closed.

In some embodiments, the interlock device further comprises a third interlock assembly configured to prevent the fourth switch from being closed when the first switch is closed, wherein the third interlock assembly comprises: a first rotating shaft extending through the mounting plate and comprising a first end located at the first side of the mounting plate and a second end located at the second side of the mounting plate; a first rotating sheet fixed to the second end of the first rotating shaft and configured to be driven by the first indicator to rotate from a first position to a second position when the first switch is switched from an open state to a close state; and a third driving assembly coupled to the first end of the first rotating shaft and configured to push a first operating bar for pressing a close button of the fourth switch away from the close button when the first rotating sheet rotates from the first position to the second position. With these embodiments, through using the third driving assembly to push the first operating bar away from the close button when the first switch is closed, the interlock device can reliably prevent the fourth switch from being closed when the first switch is closed.

In some embodiments, the third interlock assembly further comprises a third reset spring configured to reset the first rotating sheet from the second position to the first position when the first switch is switched from the close state to the open state. With these embodiments, after the first switch is opened, the first rotating sheet may be reset to the first position, such that the first operating bar is released by the third driving assembly.

In some embodiments, the third interlock assembly further comprises a fourth reset spring configured to reset the first operating bar to a position at which the first operating bar can press the close button when the first rotating sheet rotates from the second position to the first position. With these embodiments, after the first switch is opened, the first operating bar may be reset to its operating position, such that the first operating bar can be used to press the close button.

In some embodiments, the third driving assembly comprises: a third support member comprising a third through hole; a fifth link fixed to the first end of the first rotating shaft; and a driving bar coupled to the fifth link and extending through the third through hole, the driving bar being configured to push the first operating bar away from the close button when the first rotating sheet rotates from the first position to the second position. With these embodiments, the third driving assembly is simple in structure and easy to be mounted.

In some embodiments, the driving bar comprises a sixth link and a seventh link coupled to each other through fastening elements. With these embodiments, the mounting of the driving bar is easy to be implemented.

In some embodiments, the interlock device further comprises a fourth interlock assembly configured to prevent the third switch from being closed when the second switch is closed, wherein the fourth interlock assembly comprises: a second rotating shaft extending through the mounting plate and comprising a first end located at the first side of the mounting plate and a second end located at the second side of the mounting plate; a second rotating sheet fixed to the second end of the second rotating shaft and configured to be driven by the second indicator to rotate from a first position to a second position when the second switch is switched from an open state to a close state; and a fourth driving assembly coupled to the first end of the second rotating shaft and configured to push a second operating bar for pressing a close button of the third switch away from the close button when the second rotating sheet rotates from the first position to the second position. With these embodiments, through using the fourth driving assembly to push the second operating bar away from the close button when the second switch is closed, the interlock device can reliably prevent the third switch from being closed when the second switch is closed.

In a second aspect of the present disclosure, it is provided an interlock device for a bypass device. The bypass device is configured to switch a load between a main power supply and an auxiliary power supply and comprises an ATSE having a first switch coupled to the main power supply and a second switch coupled to the auxiliary power supply and a MTSE having a third switch coupled to the main power supply and a fourth switch coupled to the auxiliary power supply. The interlock device comprises: a mounting plate having a first side and a second side opposite to the first side; and a third interlock assembly configured to prevent the fourth switch from being closed when the first switch is closed. The third interlock assembly comprises: a first rotating shaft extending through the mounting plate and comprising a first end located at the first side of the mounting plate and a second end located at the second side of the mounting plate; a first rotating sheet fixed to the second end of the first rotating shaft and configured to be driven by a first indicator to rotate from a first position to a second position when the first switch is switched from an open state to a close state, wherein the first indicator is coupled to a first main shaft of the first switch; and a third driving assembly coupled to the first end of the first rotating shaft and configured to push a first operating bar for pressing a close button of the fourth switch away from the close button when the first rotating sheet rotates from the first position to the second position.

In some embodiments, the third interlock assembly further comprises a third reset spring configured to reset the first rotating sheet from the second position to the first position when the first switch is switched from the close state to the open state.

In some embodiments, the third interlock assembly further comprises a fourth reset spring configured to reset the first operating bar to a position at which the first operating bar can press the close button when the first rotating sheet rotates from the second position to the first position.

In some embodiments, the third driving assembly comprises: a third support member comprising a third through hole; a fifth link fixed to the first end of the first rotating shaft; and a driving bar coupled to the fifth link and extending through the third through hole, the driving bar being configured to push the first operating bar away from the close button when the first rotating sheet rotates from the first position to the second position.

In some embodiments, the driving bar comprises a sixth link and a seventh link coupled to each other through fastening elements.

In some embodiments, the interlock device further comprises a fourth interlock assembly configured to prevent the third switch from being closed when the second switch is closed, wherein the fourth interlock assembly comprises: a second rotating shaft extending through the mounting plate and comprising a first end located at the first side of the mounting plate and a second end located at the second side of the mounting plate; a second rotating sheet fixed to the second end of the second rotating shaft and configured to be driven by the second indicator to rotate from a first position to a second position when the second switch is switched from an open state to a close state; and a fourth driving assembly coupled to the first end of the second rotating shaft and configured to push a second operating bar for pressing a close button of the third switch away from the close button when the second rotating sheet rotates from the first position to the second position.

In a third aspect of the present disclosure, it is provided an interlock device for a bypass device. The bypass device is configured to switch a load between a main power supply and an auxiliary power supply and comprises an ATSE having a first switch coupled to the main power supply and a second switch coupled to the auxiliary power supply and a MTSE having a third switch coupled to the main power supply and a fourth switch coupled to the auxiliary power supply. The interlock device comprises: a mounting plate having a first side and a second side opposite to the first side; a first support member arranged at the first side of the mounting plate and comprising a first guiding hole extending in a first direction and a second guiding hole extending in a second direction; a first interlock assembly configured to prevent the fourth switch from being closed when the first switch is closed and comprising: a first driving assembly coupled to a first main shaft of the first switch; and a first blocker coupled to the first driving assembly and being movable along the first guiding hole in the first direction under driving of the first driving assembly when the first switch is switched between a close state and an open state, wherein the first blocker is configured to block a first indicator coupled to a fourth main shaft of the fourth switch when the first switch is in the close state and not block the first indicator when the first switch is in the open state; and a second interlock assembly configured to prevent the third switch from being closed when the second switch is closed and comprising: a second driving assembly coupled to a second main shaft of the second switch; and a second blocker coupled to the second driving assembly and being movable along the second guiding hole in the second direction under driving of the second driving assembly when the second switch is switched between a close state and an open state, wherein the second blocker is configured to block a second indicator coupled to a third main shaft of the third switch when the second switch is in the close state and not block the second indicator when the second switch is in the open state.

In a fourth aspect of the present disclosure, it is provided a bypass device comprising an interlock device described above with respect to the first, second and third aspects.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view of a bypass device

FIG. 2 schematically illustrates a perspective view of a bypass device according to an embodiment of the present disclosure;

FIG. 3 schematically illustrates a perspective view of an interlock device viewed from a first side of a mounting plate according to an embodiment of the present disclosure;

FIG. 4 schematically illustrates a perspective view of the interlock device viewed from a second side of the mounting plate according to an embodiment of the present disclosure;

FIGS. 5 and 6 schematically illustrates perspective views of a first interlock assembly and a second interlock assembly according to an embodiment of the present disclosure;

FIGS. 7 and 8 schematically illustrates exploded views of the first interlock assembly and the second interlock assembly as shown in FIGS. 5 and 6;

FIGS. 9 and 10 schematically illustrates perspective views of an interlock device viewed from the first side of the mounting plate according to an embodiment of the present disclosure; and

FIG. 11 schematically illustrates a perspective view of the interlock device viewed from the second side of the mounting plate according to an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

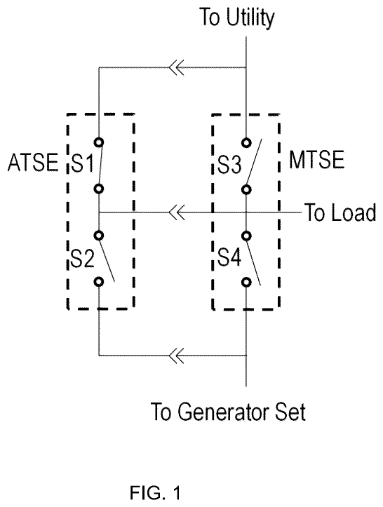

First of all, operational principles of a bypass device will be described with reference to FIG. 1.

As shown in FIG. 1, the bypass device comprises an ATSE and a MTSE. The ATSE comprises a first switch S1 and a second switch S2, and the MTSE comprises a third switch S3 and a fourth switch S4. The first switch S1 and the third switch S3 are connected to a main power supply, for example, the utility, and the second switch S2 and the fourth switch S4 are connected to an auxiliary power supply, for example, a generator set.

During a normal condition, the ATSE is used to switch the load between the main power supply and the auxiliary power supply. That is, when the main power supply is a normal state, the first switch S1 is closed (also referred to as being switched on) and the second switch S2 is opened (also referred to as being switched off), such that the load is powered by the main power supply; when the main power supply is an abnormal state, the first switch S1 is opened and the second switch S2 is closed, such that the load is powered by the auxiliary power supply. In this situation, the third switch S3 and the fourth switch S4 of the MTSE are both opened.

When the ATSE needs maintenance, the ATSE will be swung out, that is, disconnected from the main power supply, the auxiliary power supply and the load. In this situation, the MTSE will be used to switch the load between the main power supply and the auxiliary power supply. That is, when the main power supply is in the normal state, the third switch S3 is closed and the fourth switch S4 is opened, such that the load is powered by the main power supply; when the main power supply is in the abnormal state, the third switch S3 is opened and the fourth switch S4 is closed, such that the load is powered by the auxiliary power supply.

After the maintenance, when the ATSE will be swung in, that is, connected to the main power supply, the auxiliary power supply and the load. In this situation, the switches S1-S4 need to be specially positioned to avoid the main power supply and the auxiliary power supply are connected to the load at the same time, because it will lead to a short circuit between the two power supplies. For example, in the case that the third switch S3 is closed, if the second switch S2 is closed during the swinging in of the ATSE, the load will be connected to the main power supply and the auxiliary power supply at the same time, leading to the short circuit between the two power supplies.

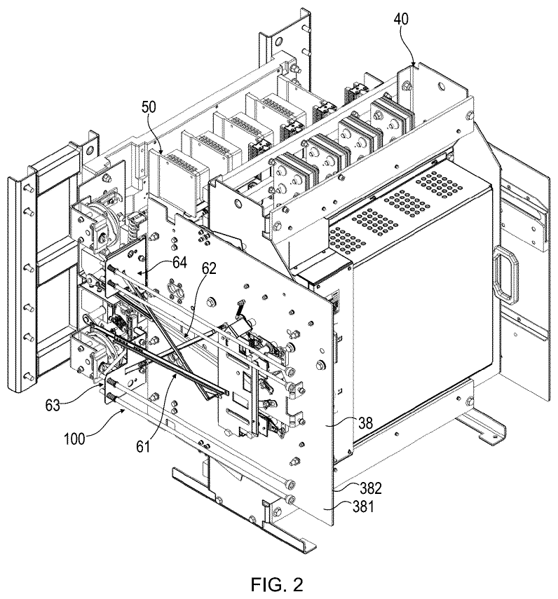

To avoid the short circuit situation, an interlock device is needed to interlock the switches S1-S4. Hereinafter, the principles of the present disclosure will be described with reference to FIGS. 2-11.

FIG. 2 schematically illustrates a perspective view of a bypass device according to an embodiment of the present disclosure. As shown in FIG. 2, the bypass device generally includes ATSE 40, MTSE 50, and an interlock device 100. The ATSE 40 is arranged in front of the MTSE 50. The interlock device 100 is coupled between the ATSE 40 and the MTSE 50 so as to achieve the interlocking function.

It is to be understood that in other embodiments, the ATSE 40 may be arranged over or under the MTSE 50. The scope of the present disclosure is not intended to be limited in this respect.

In some embodiments, as shown in FIG. 2, the interlock device 100 includes a mounting plate 38 having a first side 381 and a second side 382 opposite to the first side 381. The mounting plate 38 is used to support other components of the interlock device 100.

In some embodiments, as shown in FIG. 2, the interlock device 100 includes a first interlock assembly 61, a second interlock assembly 62, a third interlock assembly 63, and a fourth interlock assembly 64. The first interlock assembly 61 is used to prevent the first switch S1 from being closed when the fourth switch S4 is closed. The second interlock assembly 62 is used to prevent the second switch S2 from being closed when the third switch S3 is closed. The third interlock assembly 63 is used to prevent the fourth switch S4 from being closed when the first switch S1 is closed. The fourth interlock assembly 64 is used to prevent the third switch S3 from being closed when the second switch S2 is closed.

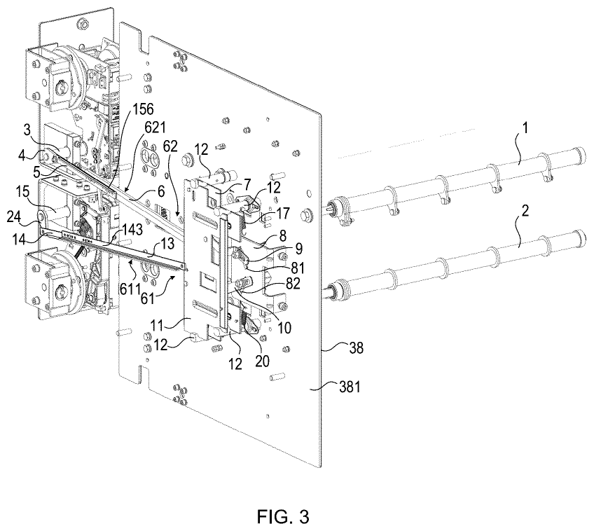

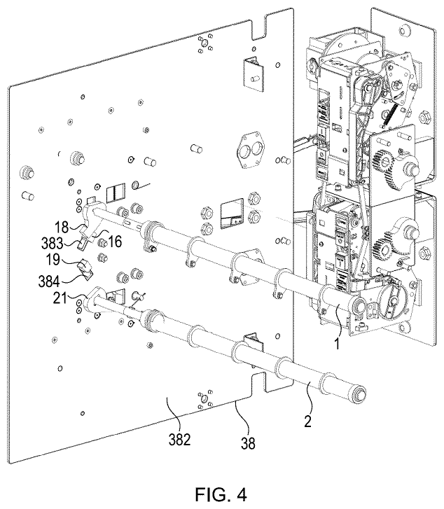

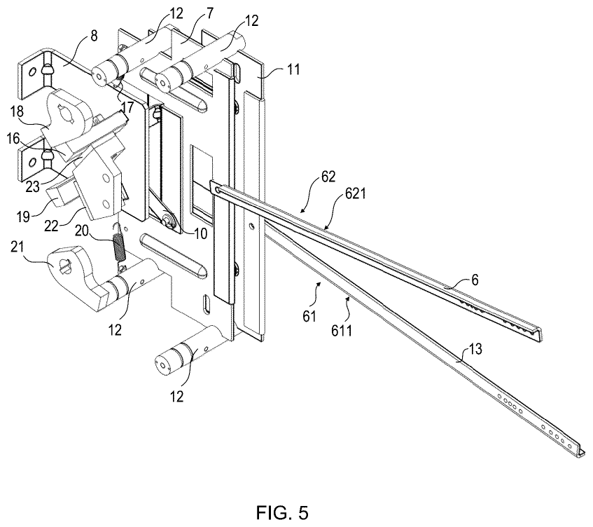

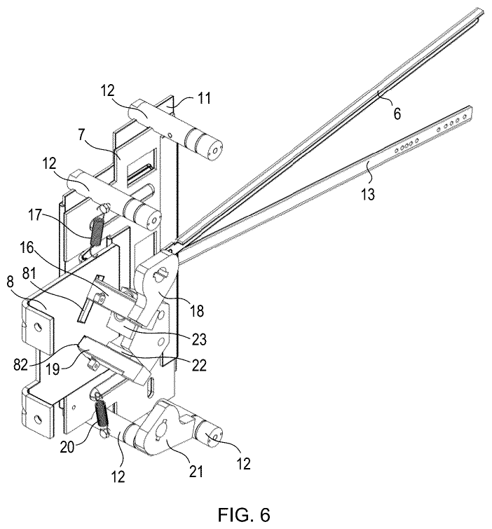

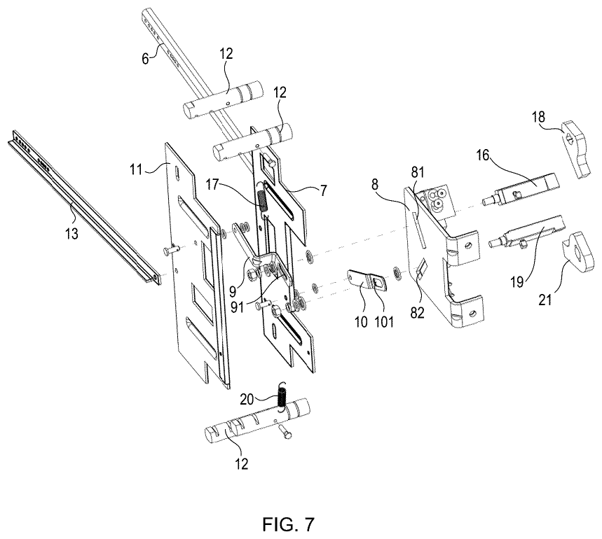

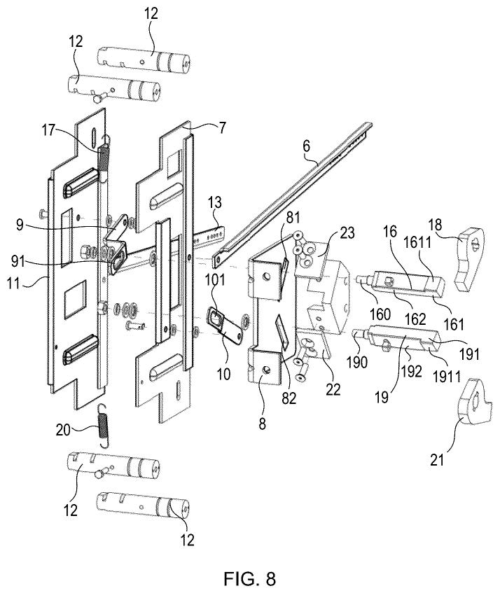

FIG. 3 schematically illustrates a perspective view of the interlock device viewed from the first side of the mounting plate according to an embodiment of the present disclosure, FIG. 4 schematically illustrates a perspective view of the interlock device viewed from the second side of the mounting plate according to an embodiment of the present disclosure, FIGS. 5 and 6 schematically illustrates perspective views of the first interlock assembly and the second interlock assembly according to an embodiment of the present disclosure, and FIGS. 7 and 8 schematically illustrates exploded views of the first interlock assembly and the second interlock assembly as shown in FIGS. 5 and 6.

In an embodiment, as shown in FIGS. 3-8, the interlock device 100 further includes a first support member 8 arranged at the first side 381 of the mounting plate 38. The first support member 8 is provided with a first guiding hole 81 extending in a first direction and a second guiding hole 82 extending in a second direction.

In some embodiments, the first direction may be at an angle with respect to the second direction. For example, the first direction may be perpendicular to the second direction. In other embodiments, the first direction may be parallel to the second direction. The scope of the present disclosure is no intended to be limited in this respect.

In an embodiment, as shown in FIGS. 3-8, the first interlock assembly 61 includes a first driving assembly 611 and a first blocker 16. The first driving assembly 611 is coupled to a fourth main shaft 15 of the fourth switch S4. The first blocker 16 is coupled to the first driving assembly 611 and is movable along the first guiding hole 81 in the first direction under driving of the first driving assembly 611 when the fourth switch S4 is switched between a close state and an open state. The first blocker 16 is configured to block a first indicator 18 coupled to a first main shaft 1 of the first switch S1 when the fourth switch S4 is in the close state and not block the first indicator 18 when the fourth switch S4 is in the open state. Through using the first blocker 16 to block the first indicator 18, the interlock device 100 can reliably prevent the first switch S1 from being closed when the fourth switch S4 is closed.

In an embodiment, as shown in FIGS. 3-8, the first driving assembly 611 includes a first cam 24, a first moving sheet 11, a first connecting member 143, and a first push bar 9. The first cam 24 is fixed to the fourth main shaft 15. The first cam 24 may rotate together with the fourth main shaft 15. The first moving sheet 11 is supported by a second support member 12 arranged at the first side 381 of the mounting plate 38. The first moving sheet 11 is movable towards or away from the fourth main shaft 15 with respect to the second support member 12. For example, the second support member 12 may include two pairs of support pillars. The first moving sheet 11 is arranged between the support pillars. Each of the support pillars may be provided with a notch (not shown). The first moving sheet 11 is clamped in the notches of the support pillars. With such an arrangement, the first moving sheet 11 may move with respect to the second support member 12. It is to be understood that in other embodiments, the first moving sheet 11 may be coupled to the second support member 12 in other manners. The scope of the present disclosure is no intended to be limited in this respect.

The first connecting member 143 is coupled between the first cam 24 and the first moving sheet 11. An end of the first connecting member 143 is rotatably coupled to the first cam 24. The other end of the first connecting member 143 is rotatably coupled to first moving sheet 11. When the fourth switch S4 is switched between the close state and the open state, the fourth main shaft 15 will rotate. Accordingly, the first cam 24 may rotate and thus drive the first moving sheet 11 via the first connecting member 143. The first connecting member 143 may push the first moving sheet 11 away from the fourth main shaft 15 when the fourth switch S4 is switched from the close state to the open state. The first connecting member 143 may pull the first moving sheet 11 towards the fourth main shaft 15 when the fourth switch S4 is switched from the open state to the close state. As shown in FIG. 3, the fourth switch S4 is in the close state. If the fourth switch S4 is switched from the close state to the open state, the first cam 24 will rotate anticlockwise and thus push the first moving sheet 11 away from the fourth main shaft 15.

The first push bar 9 is coupled between the first moving sheet 11 and the first blocker 16. The first push bar 9 may be rotatably coupled to the first moving sheet 11 at an end. The first push bar 9 may be rotatably coupled to the first blocker 16 at the other end. With such an arrangement, the first push bar 9 may push the first blocker 16 when the first moving sheet 11 moves away from the fourth main shaft 15. The first push bar 9 may push the first blocker 16 to a position at which the first indicator 18 is not blocked by the first blocker 16 when the fourth switch S4 is switched from the close state to the open state. The first push bar 9 may allow the first blocker 16 to move to a position at which the first indicator 18 is blocked by the first blocker 16 when the fourth switch S4 is switched from the open state to the close state.

In some embodiments, as shown in FIGS. 3-8, the first connecting member 143 includes a first link 14 and a second link 13 coupled to each other through fastening elements. With such an arrangement, the mounting of the first connecting member 143 is easy to be implemented. In other embodiments, the first connecting member 143 may have other structures, as long as the first connecting member 143 can drive the first moving sheet 11 to move.

In some embodiments, as shown in FIGS. 3-8, the first push bar 9 includes a first strip-shaped hole 91 coupled to the first blocker 16. A part of the first blocker 16 may be mounted in the first strip-shaped hole 91. When the fourth switch S4 is switched from the close state to the open state, an end of the first strip-shaped hole 91 may push the first blocker 16 to the position at which the first indicator 18 is not blocked by the first blocker 16. When the fourth switch S4 is switched from the open state to the close state, the first blocker 16 will be released by the first strip-shaped hole 91. In other words, the first blocker 16 will not be pushed by the end of the first strip-shaped hole 91. Then, under the action of a reset element, the first blocker 16 may return to the position at which the first indicator 18 is blocked by the first blocker 16.

In some embodiments, as shown in FIGS. 3-8, the first driving assembly 611 further includes a first reset spring 17 coupled between the second support member 12 and the first blocker 16. The first reset spring 17 may reset the first blocker 16 when the fourth switch S4 is in the close state such that the first indicator 18 is blocked by the first blocker 16.

In some embodiments, as shown in FIGS. 3-8, the first blocker 16 includes a first main part 162, a first driving part 160, and a first block part 161. The first main part 162 extends through a first through hole 383 of the mounting plate 38. The first reset spring 17 may be coupled between the second support member 12 and the first main part 162 of the first blocker 16. The first driving part 160 is arranged at an end of the first main part 162 and coupled to the first driving assembly 611. The first driving part 160 may be arranged in the first strip-shaped hole 91. The first block part 161 is arranged at the other end of the first main part 162 so as to block the first indicator 18 when the fourth switch S4 is in the close state and not block the first indicator 18 when the fourth switch S4 is in the open state.

In some embodiments, as shown in FIGS. 3-8, the first block part 161 includes a first surface 1611 inclined with respect to the first guiding hole 81 in the first direction. In this case, the first block part 161 is of a wedge-shape. The first surface 1611 is configured to block the first indicator 18 when the fourth switch S4 is in the close state. With such an arrangement, no matter whether the ATSE 40 is swung to a precise position after the maintenance, the first surface 1611 inclined with respect to the first guiding hole 81 can closely contact the first indicator 18 and block the first indicator 18 reliably when the fourth switch S4 is in the close state.

In some embodiments, as shown in FIGS. 3-8, the interlock device 100 further comprises a first brake member 23 arranged near the first guiding hole 81 at the first side 381 of the mounting plate 38. The first brake member 23 is configured to apply a friction force onto the first blocker 16 when the fourth switch S4 is in the close state. With such an arrangement, when the first indicator 18 is blocked by the first blocker 16, if the first indicator 18 tends to rotate due to an incorrect manipulation, the first indicator 18 will apply a pressing force onto the first blocker 16. In this case, the first brake member 23 may apply a friction force onto the first blocker 16, such that the first blocker 16 will not slide with respect to the first indicator 18.

In embodiments of the present disclosure, the second interlock assembly 62 may have a structure similar to that of the first interlock assembly 61, as described below with reference to FIGS. 3-8.

In an embodiment, as shown in FIGS. 3-8, the second interlock assembly 62 includes a second driving assembly 621 and a second blocker 19. The second driving assembly 621 is coupled to a third main shaft 3 of the third switch S3. The second blocker 19 is coupled to the second driving assembly 621 and is movable along the second guiding hole 82 in the second direction under driving of the second driving assembly 621 when the third switch S3 is switched between a close state and an open state. The second blocker 19 is configured to block a second indicator 21 coupled to a second main shaft 2 of the second switch S2 when the third switch S3 is in the close state and not block the second indicator 21 when the third switch S3 is in the open state. Through using the second blocker 19 to block the second indicator 21, the interlock device 100 can reliably prevent the first switch S2 from being closed when the fourth switch S3 is closed.

In an embodiment, as shown in FIGS. 3-8, the second driving assembly 621 comprises: a second cam 4 coupled to the third main shaft 3; a second moving sheet 7 supported by the second support member 12 and being movable towards or away from the third main shaft 3 with respect to the second support member 12; a second connecting member 156 coupled between the second cam 4 and the second moving sheet 7 and configured to push the second moving sheet 7 away from the third main shaft 3 when the third switch S3 is switched from the close state to the open state and pull the second moving sheet 7 towards the third main shaft 3 when the third switch S3 is switched from the open state to the close state; and a second push bar 10 coupled between the second moving sheet 7 and the second blocker 19 and configured to push the second blocker 19 to a position at which the second indicator 21 is not blocked by the second blocker 19 when the third switch S3 is switched from the close state to the open state and allow the second blocker 19 to move to a position at which the second indicator 21 is blocked by the second blocker 19 when the third switch S3 is switched from the open state to the close state.

In an embodiment, as shown in FIGS. 3-8, the second connecting member 156 comprises a third link 5 and a fourth link 6 coupled to each other through fastening elements.

In an embodiment, as shown in FIGS. 3-8, the second push bar 10 comprises a second strip-shaped hole 101 coupled to the second blocker 19.

In an embodiment, as shown in FIGS. 3-8, the second driving assembly 621 further comprises a second reset spring 20 coupled between the second support member 12 and the second blocker 19 and configured to reset the second blocker 19 when the third switch S3 is in the close state such that the second indicator 21 is blocked by the second blocker 19.

In an embodiment, as shown in FIGS. 3-8, the second blocker 19 comprises: a second main part 192 extending through a second through hole 384 of the mounting plate 38; a second driving part 190 arranged at an end of the second main part 192 and coupled to the second driving assembly 621; and a second block part 191 arranged at the other end of the second main part 192 and configured to block the second indicator 21 when the third switch S3 is in the close state and not block the second indicator 21 when the third switch S3 is in the open state.

In an embodiment, as shown in FIGS. 3-8, the second block part 191 comprises a second surface 1911 inclined with respect to the second guiding hole 82 in the second direction and configured to block the second indicator 21 when the third switch S3 is in the close state.

In an embodiment, as shown in FIGS. 3-8, the interlock device 100 further comprises a second brake member 22 arranged near the second guiding hole 82 at the first side 381 of the mounting plate 38 and configured to apply a friction force onto the second blocker 19 when the third switch S3 is in the close state.

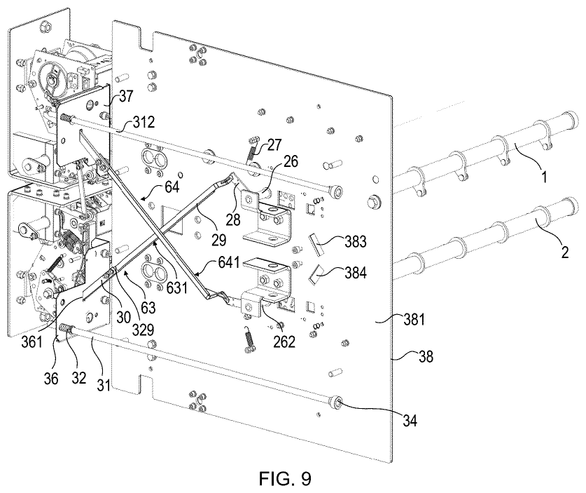

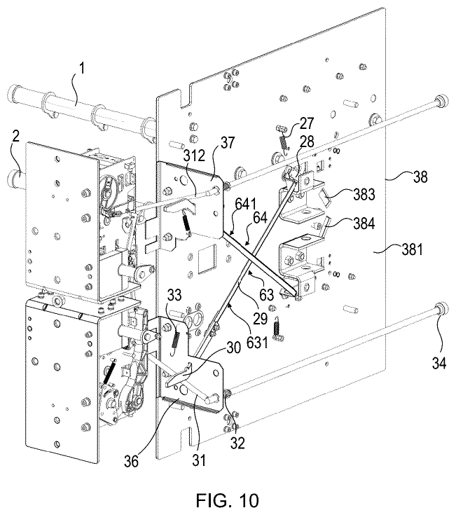

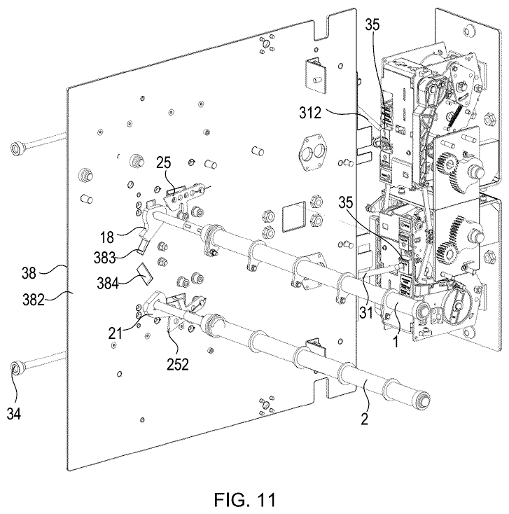

FIGS. 9 and 10 schematically illustrates perspective views of the interlock device viewed from the first side of the mounting plate according to an embodiment of the present disclosure, and FIG. 11 schematically illustrates a perspective view of the interlock device viewed from the second side of the mounting plate according to an embodiment of the present disclosure

In an embodiment, as shown in FIGS. 9-11, the third interlock assembly 63 includes a first rotating shaft 26, a first rotating sheet 25, and a third driving assembly 631. The first rotating shaft 26 extends through the mounting plate 38 and includes a first end located at the first side 381 of the mounting plate 38 and a second end located at the second side 382 of the mounting plate 38. The first rotating sheet 25 is fixed to the second end of the first rotating shaft 26 and configured to be driven by the first indicator 18 to rotate from a first position to a second position when the first switch S1 is switched from an open state to a close state. As shown in FIG. 11, as indicated by the first indicator 18, the first switch S1 is in the open state and the first rotating sheet 25 is in the first position. If the first switch S1 is switched from the open state to the close state, the first indicator 18 will rotate anticlockwise and drive the first rotating sheet 25 to rotate clockwise from the first position to the second position.

The third driving assembly 631 is coupled to the first end of the first rotating shaft 26 and configured to push a first operating bar 31 for pressing a close button 35 of the fourth switch S4 away from the close button 35 when the first rotating sheet 25 rotates from the first position to the second position. If the first operating bar 31 is pushed away from the close button 35, the close button 35 will not be able to be triggered. In this way, through using the third driving assembly 631 to push the first operating bar 31 away from the close button 35 when the first switch S1 is closed, the interlock device 100 can reliably prevent the fourth switch S4 from being closed when the first switch S1 is closed.

In an embodiment, as shown in FIGS. 9-11, the third interlock assembly 63 further includes a third reset spring 27 configured to reset the first rotating sheet 25 from the second position to the first position when the first switch S1 is switched from the close state to the open state. When the first switch S1 is switched from the close state to the open state, the first rotating sheet 25 will no longer be driven by the first indicator 18. In this case, after the first switch S1 is opened, the first rotating sheet 25 may be reset to the first position under action of the third reset spring 27, such that the first operating bar 31 is released by the third driving assembly 631.

In some embodiments, as shown in FIGS. 9-11, the third interlock assembly 63 further comprises a fourth reset spring 33 configured to reset the first operating bar 31 to a position at which the first operating bar 31 can press the close button 35 when the first rotating sheet 25 rotates from the second position to the first position. After the first rotating sheet 25 rotates from the second position to the first position, the third driving assembly 631 will no longer push the first operating bar 31. In this case, after the first switch S1 is opened, the first operating bar 31 may be reset to its operating position, such that the first operating bar 31 can be used to press the close button 35.

In some embodiments, as shown in FIGS. 9-11, the third driving assembly 631 includes a third support member 36, a fifth link 28 and a driving bar 329. The third support member 36 includes a third through hole 361. The fifth link 28 is fixed to the first end of the first rotating shaft 26. The driving bar 329 is rotatably coupled to the fifth link 28 and extends through the third through hole 361. The driving bar 329 is configured to push the first operating bar 31 away from the close button 35 when the first rotating sheet 25 rotates from the first position to the second position. It is to be understood that in other embodiments, the third driving assembly 631 may have other structures, as long as the third driving assembly 631 can push the first operating bar 31 away from the close button 35 when the first switch S1 is closed.

In some embodiments, as shown in FIGS. 9-11, the driving bar 329 comprises a sixth link 29 and a seventh link 30 coupled to each other through fastening elements. With such an arrangement, the mounting of the driving bar 329 is easy to be implemented. In other embodiments, the driving bar 329 may have other structures, as long as the driving bar 329 can push the first operating bar 31 away from the close button 35 when the first switch S1 is closed.

In an embodiment, as shown in FIGS. 9-11, the first operating bar 31 is provided with an operating button 34. An operator may press the operating button 34 so as to trigger the close button 35 when the first operating bar 31 is in its operating position. The first operating bar 31 is supported by the support member 36. The first operating bar 31 may rotate with respect to the support member 36. A fifth reset spring 32 is coupled between the first operating bar 31 and the support member 36. After the operating button 34 is released by the operator, the fifth reset spring 32 may reset the first operating bar 31.

In embodiments of the present disclosure, the fourth interlock assembly 64 may have a structure similar to that of the third interlock assembly 63, as described below with reference to FIGS. 9-11.

In some embodiments, as shown in FIGS. 9-11, the fourth interlock assembly 64 comprises: a second rotating shaft 262 extending through the mounting plate 38 and comprising a first end located at the first side 381 of the mounting plate 38 and a second end located at the second side 382 of the mounting plate 38; a second rotating sheet 252 fixed to the second end of the second rotating shaft 262 and configured to be driven by the second indicator 21 to rotate from a first position to a second position when the second switch S2 is switched from an open state to a close state; and a fourth driving assembly 641 coupled to the first end of the second rotating shaft 262 and configured to push a second operating bar 312 for pressing a close button 35 of the third switch S3 away from the close button 35 when the second rotating sheet 252 rotates from the first position to the second position. The arrangement and operation of the second rotating shaft 262, the second rotating sheet 252, and the fourth driving assembly 641 are similar to those of the first rotating shaft 26, the first rotating sheet 25, and the third driving assembly 631, and will no longer be described in detail herein.

As shown in FIGS. 1-2 and 9-11, embodiments of the present disclosure also provide an interlock device 100 for a bypass device. The bypass device is configured to switch a load between a main power supply and an auxiliary power supply and includes an ATSE 40 having a first switch S1 coupled to the main power supply and a second switch S2 coupled to the auxiliary power supply and a MTSE 50 having a third switch S3 coupled to the main power supply and a fourth switch S4 coupled to the auxiliary power supply. The interlock device 100 includes a mounting plate 38 having a first side 381 and a second side 382 opposite to the first side 381; and a third interlock assembly 63 configured to prevent the fourth switch S4 from being closed when the first switch S1 is closed. The third interlock assembly 63 comprises: a first rotating shaft 26 extending through the mounting plate 38 and comprising a first end located at the first side 381 of the mounting plate 38 and a second end located at the second side 382 of the mounting plate 38; a first rotating sheet 25 fixed to the second end of the first rotating shaft 26 and configured to be driven by a first indicator 18 to rotate from a first position to a second position when the first switch S1 is switched from an open state to a close state, wherein the first indicator 18 is coupled to a first main shaft 1 of the first switch S1; and a third driving assembly 631 coupled to the first end of the first rotating shaft 26 and configured to push a first operating bar 31 for pressing a close button 35 of the fourth switch S4 away from the close button 35 when the first rotating sheet 25 rotates from the first position to the second position.

In some embodiments, the third interlock assembly 63 further comprises a third reset spring 27 configured to reset the first rotating sheet 25 from the second position to the first position when the first switch S1 is switched from the close state to the open state.

In some embodiments, the third interlock assembly 63 further comprises a fourth reset spring 33 configured to reset the first operating bar 31 to a position at which the first operating bar 31 can press the close button 35 when the first rotating sheet 25 rotates from the second position to the first position.

In some embodiments, the third driving assembly 631 comprises: a third support member 36 comprising a third through hole 361; a fifth link 28 fixed to the first end of the first rotating shaft 26; and a driving bar 329 coupled to the fifth link 28 and extending through the third through hole 361, the driving bar 329 being configured to push the first operating bar 31 away from the close button 35 when the first rotating sheet 25 rotates from the first position to the second position.

In some embodiments, the driving bar 329 comprises a sixth link 29 and a seventh link 30 coupled to each other through fastening elements.

In some embodiments, the interlock device 100 further comprises a fourth interlock assembly 64 configured to prevent the third switch S3 from being closed when the second switch S2 is closed, wherein the fourth interlock assembly 64 comprises: a second rotating shaft 262 extending through the mounting plate 38 and comprising a first end located at the first side 381 of the mounting plate 38 and a second end located at the second side 382 of the mounting plate 38; a second rotating sheet 252 fixed to the second end of the second rotating shaft 262 and configured to be driven by the second indicator 21 to rotate from a first position to a second position when the second switch S2 is switched from an open state to a close state; and a fourth driving assembly 641 coupled to the first end of the second rotating shaft 262 and configured to push a second operating bar 312 for pressing a close button 35 of the third switch S3 away from the close button 35 when the second rotating sheet 252 rotates from the first position to the second position.

As described above with reference to FIGS. 2-8, the first interlock assembly 61 is used to prevent the first switch S1 from being closed when the fourth switch S4 is closed, and the second interlock assembly 62 is used to prevent the second switch S2 from being closed when the third switch S3 is closed. However, it is to be understood that in other embodiments, the first interlock assembly 61 may be used to prevent the fourth switch S4 from being closed when the first switch S1 is closed, and the second interlock assembly 62 may be used to prevent the third switch S3 from being closed when the second switch S2 is closed. To this end, embodiments of the present disclosure also provide an interlock device 100 for a bypass device, the bypass device being configured to switch a load between a main power supply and an auxiliary power supply and comprising an ATSE 40 having a first switch S1 coupled to the main power supply and a second switch S2 coupled to the auxiliary power supply and a MTSE 50 having a third switch S3 coupled to the main power supply and a fourth switch S4 coupled to the auxiliary power supply. The interlock device 100 comprises: a mounting plate 38 having a first side 381 and a second side 382 opposite to the first side 381; a first support member 8 arranged at the first side 381 of the mounting plate 38 and comprising a first guiding hole 81 extending in a first direction and a second guiding hole 82 extending in a second direction; a first interlock assembly 61 configured to prevent the fourth switch S4 from being closed when the first switch S1 is closed and comprising: a first driving assembly 611 coupled to a first main shaft 1 of the first switch S1; and a first blocker 16 coupled to the first driving assembly 611 and being movable along the first guiding hole 81 in the first direction under driving of the first driving assembly 611 when the first switch S1 is switched between a close state and an open state, wherein the first blocker 16 is configured to block a first indicator 18 coupled to a fourth main shaft 15 of the fourth switch S4 when the first switch S1 is in the close state and not block the first indicator 18 when the first switch S1 is in the open state; and a second interlock assembly 62 configured to prevent the third switch S3 from being closed when the second switch S2 is closed and comprising: a second driving assembly 621 coupled to a second main shaft 2 of the second switch S2; and a second blocker 19 coupled to the second driving assembly 621 and being movable along the second guiding hole 82 in the second direction under driving of the second driving assembly 621 when the second switch S2 is switched between a close state and an open state, wherein the second blocker 19 is configured to block a second indicator 21 coupled to a third main shaft 3 of the third switch S3 when the second switch S2 is in the close state and not block the second indicator 21 when the second switch S2 is in the open state.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An interlock device for a bypass device, the bypass device being configured to switch a load between a main power supply and an auxiliary power supply and comprising an Automatic Transfer Switching Equipment (ATSE) having a first switch coupled to the main power supply and a second switch coupled to the auxiliary power supply and a Manual Transfer Switching Equipment (MTSE) having a third switch coupled to the main power supply and a fourth switch coupled to the auxiliary power supply, the interlock device comprising:
a mounting plate having a first side and a second side opposite to the first side;
a first support member arranged at the first side of the mounting plate and comprising a first guiding hole extending in a first direction; and
a first interlock assembly configured to prevent the first switch from being closed when the fourth switch is closed and comprising: a first driving assembly coupled to a fourth main shaft of the fourth switch; and a first blocker coupled to the first driving assembly and being movable along the first guiding hole in the first direction under driving of the first driving assembly when the fourth switch is switched between a close state and an open state, wherein the first blocker is configured to block a first indicator coupled to a first main shaft of the first switch when the fourth switch is in the close state and not block the first indicator when the fourth switch is in the open state.

2. The interlock device according to claim 1, wherein the first driving assembly comprises:
a first cam coupled to the fourth main shaft;
a first moving sheet supported by a second support member arranged at the first side of the mounting plate and being movable towards or away from the fourth main shaft with respect to the second support member;
a first connecting member coupled between the first cam and the first moving sheet and configured to push the first moving sheet away from the fourth main shaft when the fourth switch is switched from the close state to the open state and pull the first moving sheet towards the fourth main shaft when the fourth switch is switched from the open state to the close state; and
a first push bar coupled between the first moving sheet and the first blocker and configured to push the first blocker to a position at which the first indicator is not blocked by the first blocker when the fourth switch is switched from the close state to the open state and allow the first blocker to move to a position at which the first indicator is blocked by the first blocker when the fourth switch is switched from the open state to the close state.

3. The interlock device according to claim 2, wherein the first connecting member comprises a first link and a second link coupled to each other through fastening elements.

4. The interlock device according to claim 2, wherein the first push bar comprises a first strip-shaped hole coupled to the first blocker.

5. The interlock device according to claim 2, wherein the first driving assembly further comprises a first reset spring coupled between the second support member and the first blocker and configured to reset the first blocker when the fourth switch is in the close state such that the first indicator is blocked by the first blocker.

6. The interlock device according to claim 1, wherein the first blocker comprises:
a first main part extending through a first through hole of the mounting plate;
a first driving part arranged at an end of the first main part and coupled to the first driving assembly; and
a first block part arranged at the other end of the first main part and configured to block the first indicator when the fourth switch is in the close state and not block the first indicator when the fourth switch is in the open state.

7. The interlock device according to claim 6, wherein the first block part comprises a first surface inclined with respect to the first guiding hole in the first direction and configured to block the first indicator when the fourth switch is in the close state.

8. The interlock device according to claim 7, further comprising a first brake member arranged near the first guiding hole at the first side of the mounting plate and configured to apply a friction force onto the first blocker when the fourth switch is in the close state.

9. The interlock device according to claim 1, wherein the first support member further comprises a second guiding hole extending in a second direction, and the interlock device further comprises a second interlock assembly configured to prevent the second switch from being closed when the third switch is closed and comprising:
a second driving assembly coupled to a third main shaft of the third switch; and
a second blocker coupled to the second driving assembly and being movable along the second guiding hole in the second direction under driving of the second driving assembly when the third switch is switched between a close state and an open state, wherein the second blocker is configured to block a second indicator coupled to a second main shaft of the second switch when the third switch is in the close state and not block the second indicator when the third switch is in the open state.

10. The interlock device according to claim 1, further comprising;
a third interlock assembly configured to prevent the fourth switch from being closed when the first switch is closed,
wherein the third interlock assembly comprises:
a first rotating shaft extending through the mounting plate and comprising a first end located at the first side of the mounting plate and a second end located at the second side of the mounting plate;
a first rotating sheet fixed to the second end of the first rotating shaft and configured to be driven by the first indicator to rotate from a first position to a second position when the first switch is switched from an open state to a close state; and
a third driving assembly coupled to the first end of the first rotating shaft and configured to push a first operating bar for pressing a close button of the fourth switch away from the close button when the first rotating sheet rotates from the first position to the second position.

11. The interlock device according to claim 10, wherein the third interlock assembly further comprises a third reset spring configured to reset the first rotating sheet from the second position to the first position when the first switch is switched from the close state to the open state.

12. The interlock device according to claim 10, wherein the third interlock assembly further comprises a fourth reset spring configured to reset the first operating bar to a position at which the first operating bar can press the close button when the first rotating sheet rotates from the second position to the first position.

13. The interlock device according to claim 10, wherein the third driving assembly comprises:
a third support member comprising a third through hole;
a fifth link fixed to the first end of the first rotating shaft; and
a driving bar coupled to the fifth link and extending through the third through hole, the driving bar being configured to push the first operating bar away from the close button when the first rotating sheet rotates from the first position to the second position.

14. The interlock device according to claim 13, wherein the driving bar comprises a sixth link and a seventh link coupled to each other through fastening elements.

15. The interlock device according to claim 1, further comprising;
a fourth interlock assembly configured to prevent the third switch from being closed when the second switch is closed,
wherein the fourth interlock assembly comprises:
a second rotating shaft extending through the mounting plate and comprising a first end located at the first side of the mounting plate and a second end located at the second side of the mounting plate;
a second rotating sheet fixed to the second end of the second rotating shaft and configured to be driven by the second indicator to rotate from a first position to a second position when the second switch is switched from an open state to a close state; and
a fourth driving assembly coupled to the first end of the second rotating shaft and configured to push a second operating bar for pressing a close button of the third switch away from the close button when the second rotating sheet rotates from the first position to the second position.

16. An interlock device for a bypass device, the bypass device being configured to switch a load between a main power supply and an auxiliary power supply and comprising an Automatic Transfer Switching Equipment (ATSE) having a first switch coupled to the main power supply and a second switch coupled to the auxiliary power supply and a Manual Transfer Switching Equipment (MTSE) having a third switch coupled to the main power supply and a fourth switch coupled to the auxiliary power supply, the interlock device comprising:
a mounting plate having a first side and a second side opposite to the first side; and
a third interlock assembly configured to prevent the fourth switch from being closed when the first switch is closed, wherein the third interlock assembly comprises:
a first rotating shaft extending through the mounting plate and comprising a first end located at the first side of the mounting plate and a second end located at the second side of the mounting plate;
a first rotating sheet fixed to the second end of the first rotating shaft and configured to be driven by a first indicator to rotate from a first position to a second position when the first switch is switched from an open state to a close state, wherein the first indicator is coupled to a first main shaft of the first switch; and
a third driving assembly coupled to the first end of the first rotating shaft and configured to push a first operating bar for pressing a close button of the fourth switch away from the close button when the first rotating sheet rotates from the first position to the second position.

17. The interlock device according to claim 16, wherein the third interlock assembly further comprises a third reset spring configured to reset the first rotating sheet from the second position to the first position when the first switch is switched from the close state to the open state.

18. The interlock device according to claim 16, wherein the third interlock assembly further comprises a fourth reset spring configured to reset the first operating bar to a position at which the first operating bar can press the close button when the first rotating sheet rotates from the second position to the first position.

19. The interlock device according to claim 16, wherein the third driving assembly comprises:
a third support member comprising a third through hole;
a fifth link fixed to the first end of the first rotating shaft; and
a driving bar coupled to the fifth link and extending through the third through hole, the driving bar being configured to push the first operating bar away from the close button when the first rotating sheet rotates from the first position to the second position.

20. The interlock device according to claim 19, wherein the driving bar comprises a sixth link and a seventh link coupled to each other through fastening elements.

21. The interlock device according to claim 16, further comprising a fourth interlock assembly configured to prevent the third switch from being closed when the second switch is closed, wherein the fourth interlock assembly comprises:
a second rotating shaft extending through the mounting plate and comprising a first end located at the first side of the mounting plate and a second end located at the second side of the mounting plate;
a second rotating sheet fixed to the second end of the second rotating shaft and configured to be driven by the second indicator to rotate from a first position to a second position when the second switch is switched from an open state to a close state; and
a fourth driving assembly coupled to the first end of the second rotating shaft and configured to push a second operating bar for pressing a close button of the third switch away from the close button when the second rotating sheet rotates from the first position to the second position.

22. An interlock device for a bypass device, the bypass device being configured to switch a load between a main power supply and an auxiliary power supply and comprising an Automatic Transfer Switching Equipment (ATSE) having a first switch coupled to the main power supply and a second switch coupled to the auxiliary power supply and a Manual Transfer Switching Equipment (MTSE) having a third switch coupled to the main power supply and a fourth switch coupled to the auxiliary power supply, the interlock device comprising:
a mounting plate having a first side and a second side opposite to the first side;
a first support member arranged at the first side of the mounting plate and comprising a first guiding hole extending in a first direction and a second guiding hole extending in a second direction;
a first interlock assembly configured to prevent the fourth switch from being closed when the first switch is closed and comprising: a first driving assembly coupled to a first main shaft of the first switch; and a first blocker coupled to the first driving assembly and being movable along the first guiding hole in the first direction under driving of the first driving assembly when the first switch is switched between a close state and an open state, wherein the first blocker is configured to block a first indicator coupled to a fourth main shaft of the fourth switch when the first switch is in the close state and not block the first indicator when the first switch is in the open state; and
a second interlock assembly configured to prevent the third switch from being closed when the second switch is closed and comprising: a second driving assembly coupled to a second main shaft of the second switch; and a second blocker coupled to the second driving assembly and being movable along the second guiding hole in the second direction under driving of the second driving assembly when the second switch is switched between a close state and an open state, wherein the second blocker is configured to block a second indicator coupled to a third main shaft of the third switch when the second switch is in the close state and not block the second indicator when the second switch is in the open state.

23. A bypass device comprising an interlock device according to claim 1.
